(19) United States
(12) Patent Application Publication
(10) Pub. No.: US 2020/0070481 A1
(43) Pub. Date: Mar. 5, 2020

(54) SURFACE PROTECTIVE RESIN MEMBER, MULTILAYERED RESIN MEMBER, AND SOLUTION SET

(71) Applicant: FUJI XEROX CO., LTD., Tokyo (JP)

(72) Inventor: Yoshiro YAMASHITA, Kanagawa (JP)

(73) Assignee: FUJI XEROX CO., LTD., Tokyo (JP)

(21) Appl. No.: 16/375,981

(22) Filed: Apr. 5, 2019

(30) Foreign Application Priority Data
Sep. 3, 2018 (JP) 2018-164906

(51) Int. Cl. B32B 27/08; B32B 27/40

(52) U.S. Cl. CPC B32B 27/08; C08F 2/50; B32B 27/40

(57) ABSTRACT

A surface protective resin member contains a cured product of a composition containing an acrylic resin having a hydroxyl value in a range of 40 mgKOH/g to 280 mgKOH/g, a polyol having plural hydroxyl groups linked together via a linear moiety of a carbon chain, the linear moiety having 6 or more carbon atoms, and a multifunctional isocyanate; and photocatalyst particles.

### CROSS-REFERENCE TO RELATED APPLICATIONS

This application is based on and claims priority under 35 USC 119 from Japanese Patent Application No. 2018-164906 filed Sep. 3, 2018.

### BACKGROUND

### (i) Technical Field

The present disclosure relates to a surface protective resin member, a multilayered resin member, and a solution set.

### (ii) Related Art

In order to suppress generation of surface scratches in various technical fields, surface protective resin members such as surface protective films have been disposed.

For example, Japanese Patent No. 5051282 discloses a urethane resin that is formed by polymerization of an acrylic resin containing hydroxyl groups and an isocyanate, and that has a Martens hardness at 150° C. of 1 N/mm² or more and 200 N/mm² or less and a recovery ratio at 150° C. of 80% or more and 100% or less.

Japanese Patent No. 5321721 discloses a resin material containing a polymer of a composition containing an isocyanate and an acrylic resin that has OH-group-containing side chains such that a ratio of OH-group-containing side chains having 6 or more carbon atoms relative to all the OH-group-containing side chains is more than 75 mol %.

### SUMMARY

Surface protective resin members disposed on the surfaces of substrates to protect the surfaces are designed to have high scratch resistance. In addition, some surface protective resin members used as clean members are designed to have high resistance to microorganisms.

Aspects of non-limiting embodiments of the present disclosure relate to a surface protective resin member that includes a cured product of a composition containing an acrylic resin having a hydroxyl value of 40 mgKOH/g or more and 280 mgKOH/g or less, a polyol having plural hydroxyl groups linked together via a carbon chain including 6 or more carbon atoms, and a multifunctional isocyanate, and that has high scratch resistance and high resistance to microorganisms, compared with surface protective resin members not containing photocatalyst particles.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a surface protective resin member including a cured product of a composition at least including an acrylic resin having a hydroxyl value in a range of 40 mgKOH/g to 280 mgKOH/g, a polyol having plural hydroxyl groups linked together via a linear moiety of a carbon chain, the linear moiety having 6 or more carbon atoms, and a multifunctional isocyanate; and photocatalyst particles.

### DETAILED DESCRIPTION

Hereinafter, exemplary embodiments according to the present disclosure will be described. However, the exemplary embodiments are mere examples for practicing the present disclosure, and the present disclosure is not limited to the following exemplary embodiments.

### Surface Protective Resin Member

A surface protective resin member according to an exemplary embodiment contains photocatalyst particles and a cured product of a composition at least containing an acrylic resin having a hydroxyl value of 40 mgKOH/g or more and 280 mgKOH/g or less (hereafter, also simply referred to as the “specified acrylic resin”), a polyol having plural hydroxyl groups linked together via a carbon chain having 6 or more carbon atoms (hereafter, also simply referred to as the “long-chain polyol”), and a multifunctional isocyanate.

In other words, for the surface protective resin member, the composition at least containing the specified acrylic resin (a), the long-chain polyol (b), and the multifunctional isocyanate (c) is cured to form a resin member (such as a resin layer). The resin member contains photocatalyst particles such that, for example, the photocatalyst particles are dispersed in the resin member.

This exemplary embodiment provides a surface protective resin member that has high scratch resistance and high resistance to microorganisms. The probable reason for this is as follows.

The surface protective resin member according to this exemplary embodiment contains a cured product of a composition containing the specified acrylic resin (a), the long-chain polyol (b), and the multifunctional isocyanate (c). This cured product contains urethane bonds (—NHCOO—) formed through reactions between isocyanate groups of the multifunctional isocyanate (c) and OH groups of the specified acrylic resin (a) and OH groups of the long-chain polyol (b). In short, the cured product is a polyurethane resin. Thus, the specified acrylic resin (a) forms a crosslinked structure via the long-chain polyol (b) and the multifunctional isocyanate (c), which probably results in self-healing properties of the cured product. As a result, the surface protective resin member according to this exemplary embodiment has high scratch resistance.

The surface protective resin member according to this exemplary embodiment contains photocatalyst particles. The action of the photocatalyst particles provides resistance to microorganisms in the surface of the surface protective resin member.

The term “self-healing properties” has the following meaning: even when the surface becomes scratched due to, for example, a contact (such as rubbing) with another substance, the scratches heal so that the surface recovers to the initial state or a state close to the initial state. The surface protective resin member having self-healing properties may become scratched temporarily in the surface due to, for example, a contact with another substance.

This paragraph will discuss another resin member that has self-healing properties and that does not contain photocatalyst particles but is provided with photocatalyst particles on the surface of the resin member by coating, for example. For example, when this resin member contacts with another substance and becomes temporarily scratched, the inner surfaces of the resin member are exposed from the scratches until the scratches heal. In the inner side surfaces exposed from the scratches, photocatalyst particles do not exhibit resistance to microorganisms, so that microorganisms proliferate. Even though the scratches heal due to self-healing properties and the surface recovers to the initial state, microorganisms having proliferated probably remain within the resin member.

By contrast, as described above, the surface protective resin member according to this exemplary embodiment contains photocatalyst particles. Thus, for example, even when the resin member contacts with another substance and becomes temporarily scratched in the surface, inner surfaces exposed from the scratches (namely, the inner side surfaces in the scratches) have photocatalyst particles. As a result, the antimicrobial action inhibits proliferation of microorganisms even in the temporarily formed scratches, to thereby suppress, within the resin member having healed from the scratches, remaining of microorganisms having proliferated.

In this way, the surface protective resin member according to this exemplary embodiment exhibits high scratch resistance and high resistance to microorganisms.

The surface protective resin member according to this exemplary embodiment contains photocatalyst particles, to thereby have, in addition to resistance to microorganisms, for example, deodorization properties and antifouling properties.

The surface protective resin member according to this exemplary embodiment also maintains scratch resistance for a long period of time. The probable reason for this is as follows.

In this exemplary embodiment, the photocatalyst particles exhibit antifouling properties to decompose foul substances adhering to the surface, to thereby suppress corrosion of the surface protective resin member due to foul substances. This suppresses long-term deterioration of the cured product (namely, polyurethane resin) due to corrosion caused by foul substances, so that self-healing properties of the cured product are maintained for a long period of time.

The surface protective resin member according to this exemplary embodiment also successfully maintains functions provided by photocatalyst particles, such as resistance to microorganisms, deodorization properties, and antifouling properties. The probable reason for this is as follows.

In this exemplary embodiment, for example, when the surface contacts with another substance and temporarily becomes scratched, during healing of the scratches, some of photocatalyst particles at the surface (such as exposed photocatalyst particles) may be replaced by inner photocatalyst particles (such as unexposed photocatalyst particles). Such an exchange of photocatalyst particles probably enables continuous exhibition of functions of photocatalyst particles for a long period of time.

### Formation of Surface Protective Resin Member

The method for forming the surface protective resin member according to this exemplary embodiment is not particularly limited. The surface protective resin member may be formed by, for example, curing a composition for forming a surface protective resin member, the composition containing the specified acrylic resin (a), the long-chain polyol (b), the multifunctional isocyanate (c), and photocatalyst particles.

The surface protective resin member according to this exemplary embodiment may be formed with, for example, a solution set for forming a surface protective resin member, the solution set including a first solution containing the specified acrylic resin (a) and the long-chain polyol (b), and a second solution containing the multifunctional isocyanate (c), the solution set containing photocatalyst particles.

Incidentally, the photocatalyst particles may be contained in the first solution or the second solution. Alternatively, the solution set may be provided so as to contain, in addition to the first solution and the second solution, a third solution containing photocatalyst particles. However, the photocatalyst particles are preferably contained in at least one of the first solution and the second solution, more preferably contained in the first solution.

The first solution and the second solution (and optionally another solution such as the third solution) are mixed, and applied to a base member (such as a polyimide film, an aluminum plate, or a glass plate) to form a coating film. The coating film is then heated to be cured, to thereby form a surface protective resin member.

Hereinafter, components forming the surface protective resin member according to this exemplary embodiment will be described in detail.

### Photocatalyst Particles

The surface protective resin member according to this exemplary embodiment contains photocatalyst particles. The “photocatalyst particles” are particles that provide catalysis upon irradiation with light.

Examples of the photocatalyst particles contain titanium compound particles (such as titanium oxide (TiO₂) particles), silica particles having a cover layer containing a titanium compound, and tungsten oxide particles. In particular, titanium oxide particles are preferred. Examples of titanium oxide contained in the titanium oxide particles include anatase titanium oxide and rutile titanium oxide.

Photocatalyst particles are classified into different types depending on the wavelength of light at which photocatalyst particles exhibit photocatalysis. Examples contain visible-light photocatalyst particles, which exhibit photocatalysis upon irradiation with visible light (such as light of wavelengths in a range of 380 nm or more and 800 nm or less, preferably light of wavelengths in a range of 400 nm or more and 700 nm or less), and ultraviolet photocatalyst particles, which exhibit photocatalysis upon irradiation with ultraviolet rays (light of wavelengths shorter than the wavelengths of visible light).

In this exemplary embodiment, the photocatalyst particles may be visible-light photocatalyst particles or ultraviolet photocatalyst particles, and are preferably visible-light photocatalyst particles. When visible-light photocatalyst particles are contained, even in environments with less irradiation with ultraviolet rays, such as indoors, photocatalysis (such as resistance to microorganisms, deodorization properties, and antifouling properties) tends to be exhibited. In addition, compared with ultraviolet photocatalyst particles, deterioration of the cured product (namely, polyurethane resin) tends to be suppressed.

The photocatalyst particles preferably have a number-average primary-particle size of 5 nm or more and 350 nm or less, more preferably 5 nm or more and 180 nm or less, still more preferably 5 nm or more and 150 nm or less.

When the number-average primary particle size is 350 nm or less, the surface protective resin member tends to exhibit photocatalysis (such as resistance to microorganisms, deodorization properties, and antifouling properties). In addition, opacification of the surface protective resin member is suppressed. For example, when the surface protective resin member is transparent, degradation of transparency is suppressed. On the other hand, when the number average primary particle size is 5 nm or more, the structure of the particles is maintained, which facilitates absorption of light, so that photocatalysis tends to be exhibited.

The number average primary particle size of the photocatalyst particles is measured with a transmission electron microscope (manufactured by Hitachi High-Technologies Corporation, model: H-9000). The number average primary particle size is the number average of measured particle sizes of 100 particles.

The content ratio of the photocatalyst particles relative to the entirety of the surface protective resin member is preferably 0.01 mass % or more and 30 mass % or less, more preferably 0.05 mass % or more and 20 mass % or less, still more preferably 0.08 mass % or more and 15 mass % or less.

When the content ratio of the photocatalyst particles in the surface protective resin member is 0.01 mass % or more, the surface protective resin member tends to exhibit photocatalysis (such as resistance to microorganisms, deodorization properties, and antifouling properties). On the other hand, when the content ratio of the photocatalyst particles in the surface protective resin member is 30 mass % or less, the surface protective resin member tends to exhibit self-healing properties.

The content ratio of the photocatalyst particles relative to the total mass of a solution for forming the surface protective resin member (the solution may be the above-described solution set for forming a surface protective resin member, the solution set at least containing the first solution and the second solution) is preferably 0.001 mass % or more and 10 mass % or less, more preferably 0.002 mass % or more and 8 mass % or less, still more preferably 0.003 mass % or more and 5 mass % or less.

When the content ratio of the photocatalyst particles in the solution for forming a surface protective resin member is 0.001 mass % or more, the surface protective resin member tends to exhibit photocatalysis (such as resistance to microorganisms, deodorization properties, and antifouling properties). On the other hand, when the content ratio of the photocatalyst particles in the solution for forming a surface protective resin member is 10 mass % or less, the surface protective resin member tends to exhibit self-healing properties.

The photocatalyst particles may be selected from commercially available products. Examples include “SUPER-TITANIA G series and F series” and “LUMI-RESH” manufactured by SHOWA DENKO K. K., “RENECAT” manufactured by TOSHIBA CORPORATION, titanium oxide for photocatalyst manufactured by Sakai Chemical Industry Co., Ltd., titanium oxide manufactured by Tayca Corporation, and titanium oxide manufactured by ISHIHARA SANGYO KAISHA, LTD.

The photocatalyst particles may be selected from known photocatalyst particles. Examples include metatitanic acid particles described in Japanese Laid Opened Patent Application Publication No. 2017-160116, titanium oxide particles described in Japanese Laid Opened Patent Application Publication No. 2017-159293, and silica particles having a cover layer containing a titanium compound and described in Japanese Laid Opened Patent Application Publication No. 2017-160117.

### Cured Product

The cured product contained in the surface protective resin member according to this exemplary embodiment is formed by curing a composition containing the specified acrylic resin (a), the long-chain polyol (b), and the multifunctional isocyanate (c).

### Specified Acrylic Resin (a)

This exemplary embodiment employs, as the acrylic resin, a specified acrylic resin having hydroxyl groups (—OH). This specified acrylic resin has a hydroxyl value of 40 mgKOH/g or more and 280 mgKOH/g or less.

The specified acrylic resin having hydroxyl groups may be an acrylic resin having hydroxyl groups in the molecular structure, or an acrylic resin having carboxy groups in the molecular structure.

The hydroxyl groups are introduced by, for example, employing, as a monomer for forming the specified acrylic resin, a monomer having a hydroxyl group. Examples of the monomer having a hydroxyl group include (1) an ethylenic monomer having a hydroxyl group such as hydroxymethyl (meth)acrylate, hydroxyethyl (meth)acrylate, hydroxypropyl (meth)acrylate, hydroxybutyl (meth)acrylate, or N-methylolacrylicamine.

Other examples of the monomer having a hydroxyl group include (2) an ethylenic monomer having a carboxy group such as (meth)acrylic acid, crotonic acid, itaconic acid, fumaric acid, or maleic acid.

The monomer for forming the specified acrylic resin may be used in combination with a monomer not having a hydroxyl group. Examples of the monomer not having a hydroxyl group include ethylenic monomers copolymerizable with the monomers (1) and (2), such as (meth)acrylic acid alkyl esters, for example, methyl (meth)acrylate, ethyl (meth)acrylate, propyl (meth)acrylate, butyl (meth)acrylate, n-propyl (meth)acrylate, n-butyl (meth)acrylate, isobutyl (meth)acrylate, 2-ethylhexyl (meth)acrylate, n-octyl (meth)acrylate, and n-dodecyl (meth)acrylate.

In this Specification, the term “(meth)acrylic acid” encompasses both of acrylic acid and methacrylic acid.

### Fluorine Atom

The specified acrylic resin preferably contains fluorine atoms in the molecular structure.

The photocatalyst particles such as titanium oxide particles have properties of decomposing organic components, so that the photocatalyst particles may decompose the cured product (namely, polyurethane resin) in the surface protective resin member according to this exemplary embodiment, to accelerate deterioration of the cured product. However, when the specified acrylic resin contains fluorine atoms, deterioration of the cured product is suppressed.

In addition, fluorine atoms contained in the specified acrylic resin enable alterations of the characteristics of the surface of the surface protective resin member: for example, the surface protective resin member is provided such that its surface is water-repellent in environments under no or little irradiation with light (for example, in the dark), whereas the surface turns hydrophilic due to photocatalysis in environments under irradiation with light.

Fluorine atoms are introduced by, for example, employing, as a monomer for forming the specified acrylic resin, a monomer containing a fluorine atom. Examples of the monomer containing a fluorine atom include 2-(perfluorobutyl)ethyl acrylate, 2-(perfluorobutyl)ethyl methacrylate, 2-(perfluorohexyl)ethyl acrylate, 2-(perfluorohexyl)ethyl methacrylate, perfluorohexylethylene, hexafluoropropene, hexafluoropropene epoxide, and perfluoro(propylvinyl ether).

The fluorine atoms are preferably contained in side chains of the specified acrylic resin. Such a side chain containing a fluorine atom may contain 2 or more and 20 or less carbon atoms, for example. The carbon chain of the side chain containing a fluorine atom may be linear or branched.

The number of fluorine atoms contained in a single molecule of the monomer containing a fluorine atom is not particularly limited, but is preferably, for example, 1 or more and 25 or less, more preferably 3 or more and 17 or less.

The ratio of fluorine atoms relative to the entirety of the specified acrylic resin is preferably 0.1 mass % or more and 50 mass % or less, more preferably 1 mass % or more and 20 mass % or less.

### Silane Coupling Agent

The specified acrylic resin may contain, in the molecular structure, a structure derived from a silane coupling agent.

The structure derived from a silane coupling agent is introduced by, for example, employing, as a monomer for forming the specified acrylic resin, a silane coupling agent: in other words, employing, as the monomer, a silane coupling agent having a vinyl group (CH₂═C(—R¹¹)— where R¹¹ represents a hydrogen atom or an alkyl group containing 1 or more and 8 or less carbon atoms. When the silane coupling agent having a vinyl group is employed as the monomer, the silicon-atom-containing moiety of the silane coupling agent is introduced into side chains of the specified acrylic resin (a).

The number of vinyl groups of the vinyl-group-containing silane coupling agent in a single molecular structure is preferably 1. When the silane coupling agent contains a single vinyl group, a side chain having the introduced silicon-atom-containing moiety has a free end (the other end of the side chain bonds to the main chain of the acrylic resin). Thus, such side chains have improved mobility, so that silicon-atom-containing moieties tend to be exposed at the surface of the surface protective resin member.

The vinyl-group-containing silane coupling agent is, for example, a compound having a structure represented by the following general formula (S1).

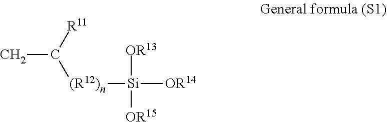

In the general formula (S1), R¹¹ represents a hydrogen atom or an alkyl group having 1 or more and 8 or less carbon atoms; R¹² represents a divalent organic group; R¹³, R¹⁴, and R¹⁵ each independently represent a hydrogen atom or an alkyl group having 1 or more and 5 or less carbon atoms; and n represents 0 or 1.

The alkyl group represented by R¹¹ may be linear or branched. Examples of the alkyl group include a methyl group, an ethyl group, and a butyl group.

R¹¹ is preferably a hydrogen atom or a methyl group.

The organic group represented by R¹² is, for example, a group containing at least one atom species selected from the atom group consisting of C, H, O, and N. Examples of the organic group include a divalent hydrocarbon group that may optionally contain a hetero atom (such as an alkylene group), a group such as —O—, —C(═O)—, or —C(═O)—O—, and groups that are combinations of two or more of the foregoing groups.

R¹² preferably represents a group that is a combination of any one group selected from —O—, —C(═O)—, and —C(═O)—O— (more preferably —C(═O)—O—), and a divalent hydrocarbon group that may optionally contain a hetero atom (more preferably an alkylene group, still more preferably an alkylene group having 2 or more and 4 or less carbon atoms). Of these, more preferred are —COO—(CH₂)₃— and —COO—(CH₂)₂—.

Preferably, n represents 1.

The alkyl groups represented by R¹³, R¹⁴, and R¹⁵ may be linear or branched. Examples include a methyl group, an ethyl group, and a butyl group.

Preferably, R¹³, R¹⁴, and R¹⁵ each independently represent a hydrogen atom, a methyl group, or an ethyl group.

Examples of the vinyl-group-containing silane coupling agent include trimethoxysilylpropyl (meth)acrylate, triethoxysilylpropyl (meth)acrylate, trimethoxysilylethyl (meth)acrylate, and triethoxysilylethyl (meth)acrylate.

Of these, preferred are trimethoxysilylpropyl (meth)acrylate and triethoxysilylpropyl (meth)acrylate.

The structure derived from a silane coupling agent is introduced by, for example, causing a reaction between a silane coupling agent having a functional group reactive to a hydroxyl group (hereafter, also simply referred to as “hydroxyl-group-reactive silane coupling agent”) and a hydroxyl group of the specified acrylic resin. As a result of the reaction between the hydroxyl-group-reactive silane coupling agent and a hydroxyl group of the specified acrylic resin, the silicon-atom-containing moiety of the silane coupling agent is introduced into a side chain of the specified acrylic resin (a). Thus, the silicon-atom-containing moiety tends to be exposed at the surface of the surface protective resin member.

Examples of the functional group reactive to a hydroxyl group include an isocyanate group (—NCO), a hydroxyl group (—OH), a carboxyl group (—COOH), and an epoxy group.

Of these, preferred is an isocyanate group.

The number of such functional groups in the hydroxyl-group-reactive silane coupling agent in a single molecular structure is preferably 1. When the number of the functional groups in the silane coupling agent is 1, side chains having the introduced silicon-atom-containing moiety have a free end (the other end bonds to the main chain of the acrylic resin). Thus, side chains have improved mobility, so that the silicon-atom-containing moieties tend to be exposed at the surface of the surface protective resin member.

The hydroxyl-group-reactive silane coupling agent is, for example, a compound having a structure represented by the following general formula (S2).

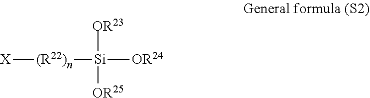

In the general formula (S2), X represents a functional group reactive to a hydroxyl group; R²² represents a divalent organic group; R²³, R²⁴, and R²⁵ each independently represent a hydrogen atom or an alkyl group having 1 or more and 3 or less carbon atoms; and n represents 0 or 1.

The organic group represented by R²² is, for example, a group containing at least one atom species selected from the atom group consisting of C, H, O, and N. Examples of the organic group include a divalent hydrocarbon group that may optionally contain a hetero atom (such as an alkylene group), a group such as —O—, —C(═O)—, or —C(═O)—O—, and groups that are combinations of two or more of the foregoing groups.

Preferably, R²² represents a divalent hydrocarbon group that may optionally include a hetero atom (more preferably an alkylene group, still more preferably an alkylene group containing 1 or more and 10 or less carbon atoms). In particular, R²² more preferably represents an ethylene group or an n-propylene group.

Preferably, n represents 1.

The alkyl groups represented by R²³, R²⁴, and R²⁵ may be linear or branched. Examples of the alkyl groups include a methyl group, an ethyl group, and a propyl group.

Preferably, R²³, R²⁴, and R²⁵ each independently represent a hydrogen atom, a methyl group, or an ethyl group.

Examples of the hydroxyl-group-reactive silane coupling agent include trimethoxysilylpropyl isocyanurate, triethoxysilylpropyl isocyanurate, trimethoxysilylethyl isocyanurate, triethoxysilylethyl isocyanurate, hydroxypropyltrimethoxysilane, hydroxypropyltriethoxysilane, hydroxyethyltrimethoxysilane, and hydroxyethyltriethoxysilane.

Of these, preferred are trimethoxysilylpropyl isocyanurate and triethoxysilylpropyl isocyanurate.

When at least one of a vinyl-group-containing silane coupling agent and a hydroxyl-group-reactive silane coupling agent is used to introduce, into a specified acrylic resin, a structure derived from the silane coupling agent, the ratio of silicon atoms (Si) relative to the entirety of the specified acrylic resin is preferably 0.01 mass % or more and 1 mass % or less, more preferably 0.1 mass % or more and 0.5 mass % or less.

### Hydroxyl Value

The specified acrylic resin has a hydroxyl value of 40 mgKOH/g or more and 280 mgKOH/g or less. The hydroxyl value is preferably 70 mgKOH/g or more and 200 mgKOH/g or less.

When the hydroxyl value is 40 mgKOH/g or more, polymerization provides a polyurethane resin having a high crosslink density. On the other hand, when the hydroxyl value is 280 mgKOH/g or less, a polyurethane resin having appropriate flexibility is obtained.

The hydroxyl value of the specified acrylic resin is adjusted by changing, for example, the ratio of hydroxyl-group-containing monomers relative to all the monomers for synthesizing the specified acrylic resin.

The hydroxyl value is the number of milligrams of potassium hydroxide for achieving acetylation of hydroxyl groups in 1 g of the sample. In this exemplary embodiment, the hydroxyl value is measured in accordance with a method (potentiometric titration) defined in JIS K0070-1992. When the sample does not dissolve, a solvent such as dioxane or tetrahydrofuran (THF) is used.

The specified acrylic resin is synthesized by, for example, mixing the above-described monomers, subjecting the monomers to standard radical polymerization or ionic polymerization, and subsequently purifying the resultant product.

### Long-Chain Polyol (b)

The long-chain polyol contains plural hydroxyl groups (—OH) linked together via a carbon chain having 6 or more carbon atoms (carbon atoms of a linear moiety linking hydroxyl groups together). In other words, in the long-chain polyol, all the hydroxyl groups are linked together via a carbon chain having 6 or more carbon atoms (carbon atoms of a linear moiety linking hydroxyl groups together).

The number of functional groups in the long-chain polyol (in other words, the number of hydroxyl groups contained in a single molecule of the long-chain polyol) may be, for example, in a range of 2 or more and 5 or less, or 2 or more and 3 or less.

In the long-chain polyol, the carbon chain having 6 or more carbon atoms is a chain in which a linear moiety of linking hydroxyl groups together has 6 or more carbon atoms. The carbon chain having 6 or more carbon atoms is, for example, an alkylene group, or a divalent group that is a combination of at least one alkylene group and at least one group selected from —O—, —C(═O)—, and —C(═O)—O—. The long-chain polyol in which hydroxyl groups are linked together via a carbon chain having 6 or more carbon atoms preferably has a structure of —[CO(CH₂)ₙ₁O]ₙ₂—H (where n1 represents 1 or more and 10 or less (preferably 3 or more and 6 or less, more preferably 5), n2 represents 1 or more and 50 or less (preferably 1 or more and 35 or less, more preferably 1 or more and 10 or less, still more preferably 2 or more and 6 or less)).

Examples of the long-chain polyol include bifunctional polycaprolactonediols, trifunctional polycaprolactonetriols, and tetra- or higher functional polycaprolactonepolyols.

Examples of the bifunctional polycaprolactonediols include a compound having two groups each represented by —[CO(CH₂)ₙ₁₁O]ₙ₁₂—H where n11 represents 1 or more and 10 or less (preferably 3 or more and 6 or less, more preferably 5), n12 represents 1 or more and 50 or less (preferably 3 or more and 35 or less), and having a hydroxyl group at the end.

In particular, preferred is a compound represented by the following general formula (1).

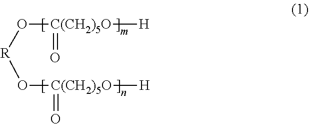

In the general formula (1), R represents an alkylene group, or a divalent group that is a combination of an alkylene group and at least one group selected from —O— and —C(═O)—; m and n each independently represent an integer of 1 or more and 35 or less.

In the general formula (1), the alkylene group included in the divalent group represented by R may be linear or branched. The alkylene group is, for example, preferably an alkylene group having 1 or more and 10 or less carbon atoms, more preferably an alkylene group having 1 or more and 5 or less carbon atoms.

The divalent group represented by R is preferably a linear or branched alkylene group having 1 or more and 10 or less carbon atoms (preferably 2 or more and 5 or less carbon atoms), or preferably a group in which two linear or branched alkylene groups having 1 or more and 5 or less carbon atoms (preferably 1 or more and 3 or less carbon atoms) are coupled via —O— or —C(═O)— (preferably —O—). In particular, more preferred are divalent groups represented by *—C₂H₄—*, *—C₂H₄OC₂H₄—*, or *—C(CH₃)₂—(CH₂)₂—*. These divalent groups are bonded at the positions *.

m and n each independently represent an integer of 1 or more and 35 or less, preferably 2 or more and 10 or less, more preferably 2 or more and 5 or less.

Examples of the trifunctional polycaprolactonetriols include a compound having three groups each represented by —[CO(CH₂)ₙ₂₁O]ₙ₂₂—H (where n21 represents 1 or more and 10 or less (preferably 3 or more and 6 or less, more preferably 5), n22 represents 1 or more and 50 or less (preferably 1 or more and 28 or less)), and having a hydroxyl group at the end. In particular, preferred is a compound represented by the following general formula (2).

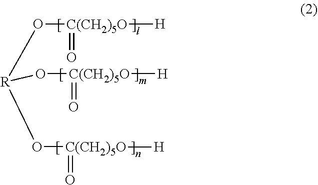

In the general formula (2), R represents a trivalent group that is provided by removing a hydrogen atom from an alkylene group, or a trivalent group that is a combination of a trivalent group provided by removing a hydrogen atom from an alkylene group, and at least one group selected from an alkylene group, —O—, and —C(═O)—. l, m, and n each independently represent an integer of 1 or more and 28 or less, and l+m+n satisfies 3 or more and 30 or less.

In the general formula (2), when R represents a trivalent group provided by removing a hydrogen atom from an alkylene group, the group may be linear or branched. For the trivalent group provided by removing a hydrogen atom from an alkylene group, the alkylene group is, for example, preferably an alkylene group having 1 or more and 10 or less carbon atoms, more preferably an alkylene group having 1 or more and 6 or less carbon atoms.

Alternatively, R may be a trivalent group that is a combination of a trivalent group provided by removing a hydrogen atom from the alkylene group, and at least one group selected from an alkylene group (for example, an alkylene group having 1 or more and 10 or less carbon atoms), —O—, and —C(═O)—.

The trivalent group represented by R is preferably a trivalent group provided by removing a hydrogen atom from a linear or branched alkylene group having 1 or more and 10 or less carbon atoms (preferably 3 or more and 6 or less carbon atoms). In particular, more preferred are trivalent groups represented by *—CH₂—CH(—*)—CH₂—*, CH₃—C(—*)(—*)—(CH₂)₂—*, or CH₃CH₂C(—*)(—*) (CH₂)₃—*. These trivalent groups are bonded at the positions *.

l, m, and n each independently represent an integer of 1 or more and 28 or less, preferably 2 or more and 10 or less, more preferably 2 or more and 5 or less. l+m+n satisfies 3 or more and 30 or less, preferably 6 or more and 30 or less, more preferably 6 or more and 20 or less.

Such long-chain polyols may be used alone or in combination of two or more thereof.

A molar ratio [OH_{P}/OH_{A}] of the hydroxyl group content [OHₚ] of the long-chain polyol (b) to the hydroxyl group content [OH_{A}] of the specified acrylic resin (a) is preferably 0.1 or more and 10 or less, more preferably 0.5 or more and 5 or less.

The long-chain polyol preferably has a hydroxyl value of 30 mgKOH/g or more and 300 mgKOH/g or less, more preferably 50 mgKOH/g or more and 250 mgKOH/g or less. When the hydroxyl value is 30 mgKOH/g or more, polymerization provides a urethane resin having a high crosslink density. On the other hand, when the hydroxyl value is 300 mgKOH/g or less, a urethane resin having appropriate flexibility tends to be obtained.

The hydroxyl value is the number of milligrams of potassium hydroxide for achieving acetylation of hydroxyl groups in 1 g of the sample. In this exemplary embodiment, the hydroxyl value is measured in accordance with a method (potentiometric titration) defined in JIS K0070-1992. When the sample does not dissolve, a solvent such as dioxane or THF is used.

### Multifunctional Isocyanate (c)

The multifunctional isocyanate (c) is a compound having plural isocyanate groups (—NCO), and reacts with, for example, hydroxyl groups of the specified acrylic resin (a) and hydroxyl groups of the long-chain polyol (b) to form urethane bonds (—NHCOO—). The multifunctional isocyanate (c) functions as a crosslinking agent that intermolecularly crosslinks the specified acrylic resin (a), that crosslinks the specified acrylic resin (a) and the long-chain polyol (b), and that intermolecularly crosslinks the long-chain polyol (b).

The multifunctional isocyanate is not particularly limited, and examples thereof include bifunctional diisocyanates such as methylene diisocyanate, toluene diisocyanate, hexamethylene diisocyanate, and isophorone diisocyanate. Other preferred examples include multifunctional isocyanates such as a polymer of hexamethylene polyisocyanate having a biuret structure, an isocyanurate structure, an adduct structure, or an elastic structure, for example.

The multifunctional isocyanate may be selected from commercially available products such as polyisocyanate (DURANATE) manufactured by Asahi Kasei Corporation.

Such multifunctional isocyanates may be used alone or in combination of two or more thereof.

The amount of multifunctional isocyanate is preferably adjusted such that the molar ratio of the isocyanate groups (—NCO) to the total amount of hydroxyl groups (—OH) in the specified acrylic resin (a) and the long-chain polyol (b) is 0.8 or more and 1.6 or less, more preferably 1 or more and 1.3 or less.

When the amount of multifunctional isocyanate satisfies the molar ratio that is 0.8 or more, polymerization provides a urethane resin having a high crosslink density. As a result, the surface protective resin member tends to have improved self-healing properties. On the other hand, when the amount of multifunctional isocyanate satisfies the molar ratio that is 1.6 or less, a urethane resin having appropriate elasticity tends to be obtained.

### Other Additives

The surface protective resin member according to this exemplary embodiment may further include other additives. Examples of the other additives include an antistatic agent, and a reaction accelerator for accelerating the reaction of hydroxyl groups (—OH) of the specified acrylic resin (a) and the long-chain polyol (b) and isocyanate groups (—NCO) of the multifunctional isocyanate (c).

### Antistatic Agent

Specific examples of the antistatic agent include cationic surfactants (such as tetraalkylammonium salts, trialkylbenzylammonium salts, hydrochloric acid salts of alkylamines, and imidazolium salts), anionic surfactants (such as alkylsulfonic acid salts, alkylbenzenesulfonic acid salts, and alkylphosphates), nonionic surfactants (such as glycerol fatty acid ester, polyoxyalkylene ether, polyoxyethylene alkylphenyl ether, N,N-bis-2-hydroxyethylalkylamine, hydroxyalkylmonoethanolamine, polyoxyethylenealkylamine, fatty acid diethanolamide, and polyoxyethylenealkylamine fatty acid ester), and amphoteric surfactants (such as alkylbetaine and alkylimidazolium betaine).

Other examples of the antistatic agent include quaternary ammonium-containing compounds.

Specific examples include tri-n-butylmethylammonium bistrifluoromethanesulfoneimide, lauryltrimethylammonium chloride, octyldimethylethylammonium ethylsulfate, didecyldimethylammonium chloride, lauryldimethylbenzylammonium chloride, stearyldimethylhydroxyethylammonium para-toluenesulfonate, tributylbenzylammonium chloride, lauryldimethylaminoacetic acid betaine, lauroylamide propylbetaine, octanamide propylbetaine, and polyoxyethylenestearylamine hydrochloric acid salts. Of these, preferred is tri-n-butylmethylammonium bistrifluoromethanesulfoneimide.

Other examples of the antistatic agent include high-molecular-weight antistatic agents.

Examples of the high-molecular-weight antistatic agents include polymers obtained by polymerizing quaternary ammonium base-containing acrylates, polystyrenesulfonic acid-based polymers, polycarboxylic acid-based polymers, polyetherester-based polymers, ethylene oxide-epichlorohydrin-based polymers, and polyetheresteramide-based polymers.

Examples of the polymers obtained by polymerizing quaternary ammonium base-containing acrylates include polymers at least including the following constitutional unit (A).

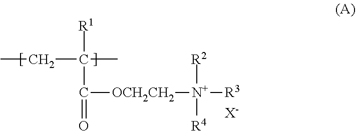

In the constitutional unit (A), R¹ represents a hydrogen atom or a methyl group; R², R³, and R⁴ each independently represent an alkyl group; and X⁻ represents an anion.

The high-molecular-weight antistatic agents can be provided by known polymerization methods.

Such a high-molecular-weight antistatic agent may be a single polymer species synthesized from the same polymerizable monomers, or may be a combination of two or more polymer species synthesized from different polymerizable monomers.

In this exemplary embodiment, the surface protective resin member is preferably formed so as to have a surface resistance in a range of 1×10⁹Ω/□ or more and 1×10¹⁴Ω/□ or less, and have a volume resistivity in a range of 1×10⁸ Ωcm or more and 1×10¹³ Ωcm or less.

The surface resistance and the volume resistivity are measured with HIRESTA UPMCP-450 equipped with a UR probe manufactured by DIA Instruments Co., Ltd., in an environment at 22° C. and 55% RH, in accordance with JIS-K6911.

When such an antistatic agent is contained, for example, the type or content of the antistatic agent may be changed, to thereby control the surface resistance and the volume resistivity of the surface protective resin member.

The antistatic agents may be used alone or in combination of two or more thereof.

### Reaction Accelerator

Examples of the reaction accelerator for accelerating the reaction of hydroxyl groups (—OH) in the specified acrylic resin (a) and the long-chain polyol (b) and isocyanate groups (—NCO) in the multifunctional isocyanate (c) include metal catalysts such as tin or bismuth catalysts.

Examples of these catalysts include NEOSTANN U-28, U-50, U-600, U-100, U-200, U-810, and tin(II) stearate manufactured by Nitto Kasei Co., Ltd.; XC-C277, XK-640, XK-628, 348, and XC-C227 manufactured by Kusumoto Chemicals, Ltd.; Borchi Kat 315, Borchi Kat 320, and Borchi Kat 24 manufactured by Borchers; and STANOCT manufactured by Mitsubishi Chemical Corporation.

### Properties of Surface Protective Resin Member

### Thickness

The surface protective resin member may be provided as a surface protective resin film, for example. The thickness of the surface protective resin film is not particularly limited; for example, the thickness is 1 μm or more and 100 μm or less, or 5 μm or more and 70 μm or less.

### Martens Hardness

The surface protective resin member according to this exemplary embodiment preferably has a Martens hardness at 23° C. of 0.5 N/mm² or more and 220 N/mm² or less, more preferably 1 N/mm² or more and 80 N/mm² or less, still more preferably 1 N/mm² or more and 70 N/mm² or less, yet more preferably 1 N/mm² or more and 5 N/mm² or less.

When the Martens hardness (23° C.) is 0.5 N/mm² or more, the resin member tends to maintain the designed shape. On the other hand, when the Martens hardness (23° C.) is 220 N/mm² or less, the probability of healing scratches (namely self-healing properties) tends to be improved.

### Recovery Ratio

The surface protective resin member according to this exemplary embodiment preferably has a recovery ratio at 23° C. of 70% or more and 100% or less, more preferably 80% or more and 100% or less, still more preferably 90% or more and 100% or less.

The recovery ratio is an index of self-healing properties (properties of recovering from strain (caused by application of a stress) within 1 min after removal of the stress, namely the degree of healing scratches) of resin materials. When the recovery ratio (23° C.) is 70% or more, the probability of healing scratches (namely, self-healing properties) is improved.

In the surface protective resin member, the Martens hardness and the recovery ratio are adjusted by controlling, for example, the hydroxyl value of the specified acrylic resin (a), the number of carbon atoms of a chain linking together hydroxyl groups in the long-chain polyol (b), the ratio of the specified acrylic resin (a) to the long-chain polyol (b), the number of functional groups (isocyanate groups) in the multifunctional isocyanate (c), or the ratio of the specified acrylic resin (a) to the multifunctional isocyanate (c).

The Martens hardness and the recovery ratio are measured with an instrument, FISCHERSCOPE HM2000 (manufactured by Fischer). A surface protective resin member (sample) is fixed on a slide glass with an adhesive, and mounted on the instrument. To the surface protective resin member, a load is applied and increased to 0.5 mN over a period of 15 seconds at a predetermined measurement temperature (for example, 23° C.), and the load of 0.5 mN is maintained for 5 seconds. In this process, the maximum displacement is measured as h1. Subsequently, the load is decreased to 0.005 mN over a period of 15 seconds, and the load of 0.005 mN is maintained for 1 minute during which the displacement is measured as h2. From h1 and h2, the recovery ratio is calculated using [(h1−h2)/h1]×100(%). In this measurement, a load-displacement curve is created, and this curve is used to determine Martens hardness.

### Multilayered Resin Member

The surface protective resin member according to this exemplary embodiment may be disposed on another resin member to provide a multilayered member. In other words, the surface protective resin member according to this exemplary embodiment (hereafter, also referred to as the “second resin member”) may be disposed on another resin member (hereafter, also referred to as the “first resin member”) to provide a multilayered resin member.

The other resin member (first resin member) used as the lower resin member preferably has high scratch resistance (in particular, self-healing properties).

The first resin member preferably includes a cured product of a composition containing an acrylic resin having a hydroxyl value of 40 mgKOH/g or more and 280 mgKOH/g or less (namely, the above-described specified acrylic resin (a)), a polyol having plural hydroxyl groups linked together via a carbon chain having 6 or more carbon atoms (namely, the above-described long-chain polyol (b)), and a multifunctional isocyanate (namely, the above-described multifunctional isocyanate (c)).

The first resin member preferably has a lower photocatalyst particle content (mass %) than the surface protective resin member according to this exemplary embodiment (second resin member). The first resin member more preferably has a photocatalyst particle content (mass %) of less than 1 mass %, still more preferably contains no photocatalyst particles (the photocatalyst particle content is 0 mass %).

This feature tends to provide improved self-healing properties. This is probably because the photocatalyst particle content is reduced for the entirety of the multilayered resin member, so that the resin exhibits its inherent flexibility. In addition, the photocatalyst particles are localized in the front surface portion of the multilayered resin member, namely, in the second resin member, so that catalysis due to photocatalyst particles tends to be exhibited, compared with a monolayered resin member that contains the same amount of photocatalyst particles dispersed throughout the entirety of the resin member.

### Applications

The surface protective resin member according to this exemplary embodiment and the multilayered resin member according to this exemplary embodiment can be used as, for example, surface protective members for articles that may become scratched in the surfaces due to contacts with other substances, and that are supposed to stay clean, more specifically, that inhibit proliferation of microorganisms therein.

Specific examples of the articles include kitchen utensils (such as chopping blocks, sinks, cooking tables, tables, floor mats, drain strainers, and dish washers), kitchen interiors (such as floor materials, tiles, wall materials, and wall papers), range hoods, ventilation fans, cooking stoves; washstands, washbowls, storage shelves for washstands, small articles for washstands, lighting fixtures for washstands; toilets (such as toilet bowls), toilet seats, toilet lids, toilet wall materials, toilet ceilings, toilet handrails, tanks, small articles for toilets; dressing tables, vanity tables; bathtubs, bathtub lids, small articles for bathtubs, bath mats, bath wall materials, bath ceilings, bathtub aprons, bathtub drain plugs, bath chairs, bath doors, basins, soap dishes, water heaters, hand dryers, bath handrails, towel racks, shower hooks, shower hoses, shower chairs, and washing machines.

Other examples of applications include building materials (such as floor materials, tiles, wall materials, and wall papers); containers (such as suitcases); containers of cosmetics; glasses (such as frames and lenses); sports goods (such as golf clubs and rackets); writing materials (such as fountain pens); musical instruments (such as the exteriors of pianos); tools for storing clothing (such as hangers); leather products (such as bags and satchels); decorative films; mirror films; automotive members (such as automotive interiors, automotive bodies, and automotive door handles); screens and other bodies in portable devices (such as cellular phones and portable gaming devices); screens of touch panels; and members of image forming apparatuses such as copy machines (such as transfer members, for example, transfer belts).

### EXAMPLES

Hereinafter, the present disclosure will be described further in detail with reference to Examples and Comparative Examples. However, the present disclosure is not limited to the following Examples. Incidentally, the terms “parts” in the following description are based on mass unless otherwise specified.

### Example 1

Preparation of photocatalyst-particle dispersion liquid Anatase titanium oxide particles (SSP-20, manufactured by Sakai Chemical Industry Co., Ltd., ultraviolet photocatalyst, number-average primary-particle size: 12 nm), isopropyl alcohol, and a dispersing agent are mixed and stirred. The mixture is subjected to dispersing treatment with an ultrasonic dispersing device, to obtain a titanium-oxide-particle dispersion liquid having a particle concentration of 20 mass % (photocatalyst-particle dispersion liquid) A1.

### Synthesis of Acrylic Resin Prepolymer A1

Polymerizable monomers that are n-butyl methacrylate (nBMA), hydroxyethyl methacrylate (HEMA), and an acrylic monomer containing a fluorine atom (FAMAC6, manufactured by UNIMATEC CO., LTD.) are mixed in a molar ratio of 25:30:5. In addition, a polymerization initiator (azobisisobutyronitrile (AIBN)) is added in an amount of 2 mass % relative to the polymerizable monomers; methyl ethyl ketone (MEK) is added in an amount of 40 mass % relative to the polymerizable monomers to prepare a polymerizable monomer solution.

The polymerizable monomer solution is charged into a dropping funnel, and dropped over a period of 3 hours in a nitrogen atmosphere under reflux, into MEK that is stirred, that is heated at 80° C., and that has an amount of 50 mass % relative to the polymerizable monomers, to thereby cause polymerization. Subsequently, a solution composed of MEK in an amount of 10 mass % relative to the polymerizable monomers and AIBN in an amount of 0.5 mass % relative to the polymerizable monomers is dropped over a period of 1 hour, to complete the reaction. During the reaction, the reaction solution is kept at 80° C. and continuously stirred. Thus, an acrylic resin prepolymer A1 is synthesized.

The obtained acrylic resin prepolymer A1 is measured for hydroxyl value in accordance with a method (potentiometric titration) defined in JIS K0070-1992. The hydroxyl value is found to be 175 mgKOH/g.

The acrylic resin prepolymer A1 is measured for weight-average molecular weight by the above-described method using gel permeation chromatography (GPC). The weight-average molecular weight is found to be 17000.

### Preparation of Resin-Film-Forming Solution (A1)

The following components except for the titanium-oxide-particle dispersion liquid A1 are mixed together and stirred. To the mixture, the titanium-oxide-particle dispersion liquid A1 is added and stirred, to thereby prepare a first solution A1.

Acrylic resin prepolymer A1 solution (solid content: 50 mass %): 40 parts

Long-chain polyol (polycaprolactonetriol, PLACCEL 312, manufactured by Daicel Corporation, molecular weight: 1250, hydroxyl value: 130 to 140 mgKOH/g): 29.5 parts

Methyl ethyl ketone: 30 parts

Titanium-oxide-particle dispersion liquid (photocatalyst-particle dispersion liquid) A1: 4 parts

In addition, the following second solution A1 is prepared.

Second solution A1 (multifunctional isocyanate, DURANATE TPA100, manufactured by Asahi Kasei Chemicals Corporation, compound name: polyisocyanurate of hexamethylene diisocyanate): 30 parts

To the first solution A1, the second solution A1 is added, stirred, and defoamed in a reduced pressure for 5 minutes. Furthermore, a reaction catalyst (inorganic bismuth) is added, to provide a resin-film-forming solution (A1).

### Preparation of Resin-Film-Forming Solution (B1)

The same procedures as in the preparation of the resin-film-forming solution (A1) are performed except that the first solution A1 is prepared without addition of the titanium-oxide-particle dispersion liquid A1. Thus, a resin-film-forming solution (B1) is obtained.

### Formation of Multilayered Resin Film (1)

The resin-film-forming solution (B1) is applied to, with a wire bar, a polyimide film so as to have a thickness of 35 μm, and subsequently cured at 80° C. for 1 hour and then at 130° C. for 30 minutes, to obtain, as a lower layer, a coating film having an average thickness of 20 μm.

On this coating film, the resin-film-forming solution (A1) is applied so as to have a thickness of 35 μm, cured at 80° C. for 1 hour and then at 130° C. for 30 minutes, to form an upper layer having an average thickness of 20 μm.

In this way, a multilayered resin film (1) having an average thickness of 40 μm is obtained in which the upper layer containing titanium oxide particles is disposed on the lower layer not containing titanium oxide particles.

### Example 2

The same procedures as in Example 1 are performed except that the acrylic resin prepolymer A1 in Example 1 is changed to the following acrylic resin prepolymer A2 not containing fluorine atoms, to thereby obtain a multilayered resin film.

### Synthesis of Acrylic Resin Prepolymer A2

The same procedures as in the synthesis of the acrylic resin prepolymer A1 in Example 1 are performed except that, without using the acrylic monomer containing a fluorine atom (FAMAC6, manufactured by UNIMATEC CO., LTD.), the polymerizable monomers that are n-butyl methacrylate (nBMA) and hydroxyethyl methacrylate (HEMA) are mixed in a molar ratio of 30:30 to synthesize a prepolymer that is an acrylic resin prepolymer A2.

The obtained acrylic resin prepolymer A2 is found to have a hydroxyl value of 206 mgKOH/g.

### Example 3

The same procedures as in Example 1 are performed except that the anatase titanium oxide particles (SSP-20, manufactured by Sakai Chemical Industry Co., Ltd., number average primary particle size: 12 nm) in Example 1 are changed to anatase titanium oxide particles (model: AMT-100, manufactured by Tayca Corporation, ultraviolet photocatalyst, number average primary particle size: 6 nm), to thereby obtain a multilayered resin film.

### Example 4

The same procedures as in Example 1 are performed except that the anatase titanium oxide particles (SSP-20, manufactured by Sakai Chemical Industry Co., Ltd., number average primary particle size: 12 nm) in Example 1 are changed to anatase titanium oxide particles (model: ST-41, manufactured by ISHIHARA SANGYO KAISHA, LTD., ultraviolet photocatalyst, number average primary particle size: 200 nm), to thereby obtain a multilayered resin film.

### Example 5

The same procedures as in Example 1 are performed except that the anatase titanium oxide particles (SSP-20, manufactured by Sakai Chemical Industry Co., Ltd., number average primary particle size: 12 nm) in Example 1 are changed to platinum-compound-treated titanium oxide particles (model: MPT-623, manufactured by ISHIHARA SANGYO KAISHA, LTD., visible-light photocatalyst, number average primary particle size: 18 nm), to thereby obtain a multilayered resin film.

### Example 6

The same procedures as in Example 1 are performed except that the amount of titanium oxide particle dispersion liquid in the first solution A1 in Example 1 is changed such that the upper layer has a photocatalyst particle content (mass %) described in Table 1 below, to thereby obtain a multilayered resin film.

### Example 7

The same procedures as in Example 1 are performed except that the titanium oxide particle dispersion liquid (photocatalyst particle dispersion liquid) A1 in Example 1 is concentrated and then the amount of titanium oxide particle dispersion liquid in the first solution A1 is changed such that the upper layer has a photocatalyst particle content (mass %) described in Table 1 below, to thereby obtain a multilayered resin film.

### Example 8

The resin film forming solution (A1) prepared in Example 1 is applied so as to have a thickness of 55 μm, cured at 80° C. for 1 hour and then at 130° C. for 30 minutes, to thereby obtain a monolayered resin film (8) having an average thickness of 30 μm.

### Comparative Example 1

The same procedures as in Example 8 are performed except that the amount of titanium oxide particle dispersion liquid in the first solution A1 is changed (to 0 parts) such that the monolayered resin film has a photocatalyst particle content (mass %) described in Table 1 below, specifically, the film does not contain photocatalyst particles, to thereby obtain a monolayered resin film.

### Evaluations

### Self-Healing Properties (Recovery Ratio)

The multilayered resin films and the monolayered resin films obtained in Examples and Comparative Example are measured for recovery ratio (%) as the index of self-healing properties. The recovery ratio is measured with an instrument, FISCHERSCOPE HM2000 (manufactured by Fischer). A sample is fixed on a slide glass with an adhesive, and mounted on the instrument. At 23° C., to the sample, a load is applied and increased to 0.5 mN over a period of 15 seconds, and the load of 0.5 mN is maintained for 5 seconds. In this process, the maximum displacement is measured as h1. Subsequently, the load is decreased to 0.005 mN over a period of 15 seconds, and the load of 0.005 mN is maintained for 1 minute during which the displacement is measured as h2. From h1 and h2, the recovery ratio is calculated using [(h1−h2)/h1]×100(%).

### Antifouling Properties/Decomposability (Variation)

Onto each of the multilayered resin films and the monolayered resin films obtained in Examples and Comparative Example, 10 μl of a methylene blue diluted solution is dropped, and covered with a cover glass. The resin film is irradiated with black light (illuminance: 0.5 mW/cm²) for 7 hours, and then washed with water and alcohol. Before and after the irradiation, the resin film is measured for transmittance (%) in the methylene blue wavelength region, with a spectrophotometer (manufactured by Hitachi, Ltd., model: U-4100). From the measured transmittances, the variation before and after the irradiation is calculated using (preirradiation transmittance−postirradiation transmittance)/preirradiation transmittance×100(%).

Incidentally, in Example 5, instead of the black light, a light-emitting diode that emits visible light of wavelengths of 400 nm to 550 nm is used.

### Long-Term Deterioration Test (Recovery Ratio and Variation)

Onto each of the multilayered resin films and the monolayered resin films obtained in Examples and Comparative Example, 10 μl of a methylene blue diluted solution is dropped, and covered with a cover glass. The resin film is irradiated with black light (illuminance: 0.5 mW/cm²) for 2 hours, then washed with water and alcohol, and then rubbed with a brass brush 5 times. These procedures are defined as a single set, and 30 sets of the procedures are performed.

After this long-term deterioration test, each resin film is measured for recovery ratio by the above-described method.

In addition, before and after the long-term deterioration test, each resin film is measured for transmittance (%) in the methylene blue wavelength region by the above-described method. From the measured transmittances, the variation before and after the test is calculated.

Incidentally, in Example 5, instead of the black light, a light-emitting diode that emits visible light of wavelengths of 400 nm to 550 nm is used.

### Resistance to Microorganisms

Each of the multilayered resin films and the monolayered resin films obtained in Examples and Comparative Example is rubbed with a brass brush 5 times; a culture of E. coli is then dropped onto the resin film, and covered with a cover glass; the resin film is irradiated with a white fluorescent lamp at an illuminance of 2000 lx for 4 hours; subsequently, the remaining E. coli is collected with physiological saline, and the survival rate (%) of E. coli is calculated.

TABLE 1

| | | Upper layer (or monolayer) | | | Lower layer | | | Photocatalyst particles | |
|---|---|---|---|---|---|---|---|---|---|
| | | Photocatalyst | Film | Acrylic resin | Photocatalyst | Film | Acrylic resin | Particle | |
| | Layer | particle content | thickness | F atoms | particle content | thickness | F atoms are | size | |
| | configuration | [mass %] | [μm] | are contained or not | [mass %] | [μm] | contained or not | [nm] | Type |
| Example 1 | Multilayered | 1% | 20 | Contained | 0% | 20 | Contained | 12 | Ultraviolet |
| Example 2 | Multilayered | 1% | 20 | Not contained | 0% | 20 | Not contained | 12 | Ultraviolet |
| Example 3 | Multilayered | 1% | 20 | Contained | 0% | 20 | Contained | 6 | Ultraviolet |
| Example 4 | Multilayered | 1% | 20 | Contained | 0% | 20 | Contained | 200 | Ultraviolet |
| Example 5 | Multilayered | 1% | 20 | Contained | 0% | 20 | Contained | 18 | Visible light |
| Example 6 | Multilayered | 0.01% | 20 | Contained | 0% | 20 | Contained | 12 | Ultraviolet |
| Example 7 | Multilayered | 20% | 20 | Contained | 0% | 20 | Contained | 12 | Ultraviolet |
| Example 8 | Monolayered | 1% | 30 | Contained | — | | | 12 | Ultraviolet |
| Comparative | Monolayered | 0% | 30 | Contained | — | | | — | |
| Example 1 | | | | | | | | | |

TABLE 2

| | Evaluations | | | | |
|---|---|---|---|---|---|
| | Self-healing | Antifouling | After long-term deterioration | After long-term deterioration | |
| | properties | properties | self-healing properties | antifouling properties | |
| | (recovery ratio) | (variation) | (recovery ratio) | (variation) | Resistance to |
| | [%] | [%] | [%] | [%] | microorganisms |
| Example 1 | 98% | 5% or less | 97% | 5% or less | 15% or less |
| Example 2 | 98% | 6% | 97% | 6% | 15% or less |
| Example 3 | 98% | 5% or less | 95% | 5% or less | 15% or less |
| Example 4 | 96% | 7% | 95% | 10% | 20% |
| Example 5 | 98% | 5% or less | 97% | 5% or less | 15% or less |
| Example 6 | 99.5% | 6% | 99% | 9% | 20% |
| Example 7 | 91% | 5% or less | 90% | 5% or less | 15% or less |
| Example 8 | 97% | 5% or less | 96% | 5% or less | 15% or less |
| Comparative | 99.5% | 20% | 97% | 30% | 70% or more |
| Example 1 | | | | | |

### Example 9

### Preparation of Photocatalyst-Particle Dispersion Liquid

A copper compound-titanium oxide powder (LUMI-RESH CT-2, manufactured by SHOWA DENKO K. K., visible-light photocatalyst, primary-particle size: 100 nm), isopropyl alcohol, and a dispersing agent are mixed and stirred. The mixture is subjected to a dispersing treatment with an ultrasonic dispersing device, to obtain a photocatalyst-particle dispersion liquid A9 having a particle concentration of 20 mass %.

### Synthesis of Acrylic Resin Prepolymer A9

Polymerizable monomers that are n-butyl methacrylate (nBMA), hydroxyethyl methacrylate (HEMA), and an acrylic monomer containing a fluorine atom (FAMAC6, manufactured by UNIMATEC CO., LTD.) are mixed in a molar ratio of 30:23:7. In addition, a polymerization initiator (AIBN) is added in an amount of 2 mass % relative to the polymerizable monomers; and butyl acetate is added in an amount of 40 mass % relative to the polymerizable monomers to prepare a polymerizable monomer solution.

The polymerizable monomer solution is charged into a dropping funnel, and dropped over a period of 3 hours in a nitrogen atmosphere under reflux, into butyl acetate that is stirred, that is heated at 80° C., and that has an amount of 50 mass % relative to the polymerizable monomers, to thereby cause polymerization. Subsequently, a solution composed of butyl acetate in an amount of 10 mass % relative to the polymerizable monomers and AIBN in an amount of 0.5 mass % relative to the polymerizable monomers is dropped over a period of 1 hour, to complete the reaction. During the reaction, the reaction solution is kept at 80° C. and continuously stirred. Thus, an acrylic resin prepolymer A9 is synthesized.

The obtained acrylic resin prepolymer A9 is measured for hydroxyl value in accordance with a method (potentiometric titration) defined in JIS K0070-1992. The hydroxyl value is found to be 125 mgKOH/g.

The acrylic resin prepolymer A9 is measured for weight-average molecular weight by the above-described method using gel permeation chromatography (GPC). The weight-average molecular weight is found to be 14000.

### Preparation of Resin-Film-Forming Solution (A9)

The following components except for the photocatalyst-particle dispersion liquid A9 are mixed and stirred. To the mixture, the photocatalyst-particle dispersion liquid A9 is added and stirred to thereby prepare a first solution A9.

Acrylic resin prepolymer A9 solution (solid content: 40 mass %): 50 parts

Long-chain polyol (polycaprolactonetriol, PLACCEL 308, manufactured by Daicel Corporation, molecular weight: 850, hydroxyl value: 190 to 200 mgKOH/g): 10 parts

Butyl acetate: 10 parts

Photocatalyst-particle dispersion liquid A9: 1.1 parts

In addition, the following second solution A9 is prepared.

Second solution A9 (multifunctional isocyanate, DURANATE TPA100, manufactured by Asahi Kasei Chemicals Corporation, compound name: polyisocyanurate of hexamethylene diisocyanate): 15 parts

To the first solution A9, the second solution A9 is added, stirred, and defoamed for 5 minutes under a reduced pressure. Furthermore, a reaction catalyst (inorganic bismuth) is added, to thereby provide a resin-film-forming solution (A9).

### Formation of Monolayered Resin Film (9)

The resin-film-forming solution (A9) is applied so as to have a thickness of 70 μm, and cured at 80° C. for 1.5 hours and then at 130° C. for 30 minutes, to obtain a monolayered resin film (9) having an average thickness of 35 m.

### Example 10

### Synthesis of Acrylic Resin Prepolymer A10

Polymerizable monomers that are n-butyl methacrylate (nBMA), hydroxyethyl methacrylate (HEMA), and an acrylic monomer containing a fluorine atom (FAMAC6, manufactured by UNIMATEC CO., LTD.) are mixed in a molar ratio of 24:50:3. In addition, a polymerization initiator (AIBN) is added in an amount of 2 mass % relative to the polymerizable monomers; and methyl ethyl ketone (MEK) is added in an amount of 40 mass % relative to the polymerizable monomers to thereby prepare a polymerizable monomer solution.

The polymerizable monomer solution is charged into a dropping funnel, and dropped over a period of 3 hours in a nitrogen atmosphere under reflux, into MEK that is stirred, that is heated at 80° C., and that has an amount of 50 mass % relative to the polymerizable monomers, to thereby cause polymerization. Subsequently, a solution composed of MEK in an amount of 10 mass % relative to the polymerizable monomers and AIBN in an amount of 0.5 mass % relative to the polymerizable monomers is dropped over a period of 1 hour, to complete the reaction. During the reaction, the reaction solution is kept at 80° C. and continuously stirred. Thus, an acrylic resin prepolymer A10 is synthesized.

The obtained acrylic resin prepolymer A10 is measured for hydroxyl value in accordance with a method (potentiometric titration) defined in JIS K0070-1992. The hydroxyl value is found to be 250 mgKOH/g.

The acrylic resin prepolymer A10 is measured for weight-average molecular weight by the above-described method using gel permeation chromatography (GPC). The weight-average molecular weight is found to be 19000.

### Preparation of Resin-Film-Forming Solution (A10)

As in Example 9, the following components except for the photocatalyst-particle dispersion liquid A9 are mixed and stirred. To the mixture, the photocatalyst-particle dispersion liquid A9 is added and stirred to thereby prepare a first solution A10.

Acrylic resin prepolymer A10 solution (solid content: 45 mass %): 33 parts

Long-chain polyol (polycaprolactonetriol, PLACCEL 305, manufactured by Daicel Corporation, molecular weight: 550, hydroxyl value: 300 to 310 mgKOH/g): 25 parts

Methyl ethyl ketone (MEK): 50 parts

Photocatalyst-particle dispersion liquid A9: 8.2 parts

In addition, the following second solution A10 is prepared.

Second solution A10 (multifunctional isocyanate, DURANATE TPA100, manufactured by Asahi Kasei Chemicals Corporation, compound name: polyisocyanurate of hexamethylene diisocyanate): 40 parts

To the first solution A10, the second solution A10 is added, stirred, and defoamed for 5 minutes under a reduced pressure. Furthermore, a reaction catalyst (inorganic bismuth) is added, to provide a resin-film-forming solution (A10).

### Formation of Monolayered Resin Film (10)

The resin-film-forming solution (A10) is applied so as to have a thickness of 70 μm, and cured at 80° C. for 1 hour and then at 130° C. for 30 minutes, to obtain a monolayered resin film (10) having an average thickness of 35 m.

### Example 11

### Synthesis of Acrylic Resin Prepolymer A11

Polymerizable monomers that are n-butyl methacrylate (nBMA), hydroxyethyl methacrylate (HEMA), and an acrylic monomer containing a fluorine atom (FAMAC6, manufactured by UNIMATEC CO., LTD.) are mixed in a molar ratio of 20:35:5. In addition, a polymerization initiator (AIBN) is added in an amount of 2 mass % relative to the polymerizable monomers; and butyl acetate is added in an amount of 40 mass % relative to the polymerizable monomers to prepare a polymerizable monomer solution.

The polymerizable monomer solution is charged into a dropping funnel, and dropped over a period of 3 hours in a nitrogen atmosphere under reflux, into butyl acetate that is stirred, that is heated at 80° C., and that has an amount of 50 mass % relative to the polymerizable monomers, to thereby cause polymerization. Subsequently, a solution composed of butyl acetate in an amount of 10 mass % relative to the polymerizable monomers and AIBN in an amount of 0.5 mass % relative to the polymerizable monomers is dropped over a period of 1 hour, to complete the reaction. During the reaction, the reaction solution is kept at 80° C. and continuously stirred. Thus, an acrylic resin prepolymer A11 is synthesized.

The obtained acrylic resin prepolymer A11 is measured for hydroxyl value in accordance with a method (potentiometric titration) defined in JIS K0070-1992. The hydroxyl value is found to be 205 mgKOH/g.

The acrylic resin prepolymer A11 is measured for weight-average molecular weight by the above-described method using gel permeation chromatography (GPC). The weight-average molecular weight is found to be 18000.

Preparation of resin-film-forming solution (A11) The following components except for the photocatalyst-particle dispersion liquid A9 are mixed and stirred. To the mixture, the photocatalyst-particle dispersion liquid A9 is added and stirred to thereby prepare a first solution A11.

Acrylic resin prepolymer A11 solution (solid content: 50 mass %): 50 parts

Long-chain polyol (polycaprolactonetriol, PLACCEL 308, manufactured by Daicel Corporation, molecular weight: 850, hydroxyl value: 190 to 200 mgKOH/g): 26 parts

Butyl acetate: 45 parts

Photocatalyst-particle dispersion liquid A9: 4.4 parts

In addition, the following second solution A11 is prepared.

Second solution A11 (multifunctional isocyanate, DURANATE TPA100, manufactured by Asahi Kasei Chemicals Corporation, compound name: polyisocyanurate of hexamethylene diisocyanate): 36 parts

To the first solution A11, the second solution A11 is added, stirred, and defoamed for 5 minutes under a reduced pressure. Furthermore, a reaction catalyst (inorganic tin) is added, to provide a resin-film-forming solution (A11).

Formation of monolayered resin film (11) The resin-film-forming solution (A11) is applied so as to have a thickness of 75 μm, and cured at 80° C. for 2 hours and then at 130° C. for 30 minutes, to obtain a monolayered resin film (11) having an average thickness of 40 μm.

### Example 12

### Preparation of Resin-Film-Forming Solution (A12)

As in Example 9, the following components except for the photocatalyst-particle dispersion liquid A9 are mixed and stirred. To the mixture, the photocatalyst-particle dispersion liquid A9 is added and stirred to prepare a first solution A12.

Acrylic resin prepolymer A11 solution (solid content: 50 mass %): 50 parts

Long-chain polyol (polycaprolactonetriol, PLACCEL 308, manufactured by Daicel Corporation, molecular weight: 850, hydroxyl value: 190 to 200 mgKOH/g): 26 parts

Methyl ethyl ketone (MEK): 45 parts

Photocatalyst-particle dispersion liquid A9: 0.4 parts

To the first solution A12, the second solution A11 used in Example 11 is added, stirred, and defoamed for 5 minutes under a reduced pressure. Furthermore, a reaction catalyst (inorganic bismuth) is added, to provide a resin-film-forming solution (A12).

### Formation of Monolayered Resin Film (12)

The resin-film-forming solution (A12) is applied so as to have a thickness of 60 μm, and cured at 80° C. for 1 hour and then at 130° C. for 30 minutes, to obtain a monolayered resin film (12) having an average thickness of 35 μm.

### Example 13

The same procedures as in Example 12 are performed except that the photocatalyst-particle dispersion liquid A9 in Example 9 is concentrated and the amount of photocatalyst-particle dispersion liquid in the first solution A12 is adjusted such that the monolayered resin film has a photocatalyst particle content (mass %) described in Table 3 below, to thereby obtain a monolayered resin film (13).

### Example 14

The same procedures as in Example 12 are performed except that the amount of photocatalyst-particle dispersion liquid in the first solution A12 is adjusted such that the monolayered resin film has a photocatalyst particle content (mass %) described in Table 3 below, to thereby obtain a monolayered resin film (14).

### Example 15

### Preparation of Resin-Film-Forming Solution (A15)

As in Example 9, the following components except for the photocatalyst-particle dispersion liquid A9 are mixed and stirred. To the mixture, the photocatalyst-particle dispersion liquid A9 is added and stirred to prepare a first solution A15.

Acrylic resin prepolymer A11 solution (solid content: 50 mass %): 50 parts

Long-chain polyol (polycaprolactonetriol, PLACCEL 308, manufactured by Daicel Corporation, molecular weight: 850, hydroxyl value: 190 to 200 mgKOH/g): 26 parts

Ethylbenzene: 20 parts

Toluene: 15 parts

Xylene: 10 parts

Photocatalyst-particle dispersion liquid A9: 4.4 parts

To the first solution A15, the second solution A11 used in Example 11 is added, stirred, and defoamed for 5 minutes under a reduced pressure. Furthermore, a reaction catalyst (inorganic bismuth) is added, to provide a resin-film-forming solution (A15).

### Formation of Monolayered Resin Film (15)

The resin-film-forming solution (A15) is applied so as to have a thickness of 55 μm, and cured at 80° C. for 2 hours and then at 130° C. for 30 minutes, to obtain a monolayered resin film (15) having an average thickness of 30 μm.

### Example 16

### Preparation of Resin-Film-Forming Solution (A16)

As in Example 9, the following components except for the photocatalyst-particle dispersion liquid A9 are mixed and stirred. To the mixture, the photocatalyst-particle dispersion liquid A9 is added and stirred to prepare a first solution A16.

Acrylic resin prepolymer A11 solution (solid content: 50 mass %): 50 parts

Long-chain polyol (polycaprolactonetriol, PLACCEL 308, manufactured by Daicel Corporation, molecular weight: 850, hydroxyl value: 190 to 200 mgKOH/g): 26 parts

Methylcyclohexane: 20 parts

Butyl acetate: 25 parts

Photocatalyst-particle dispersion liquid A9: 3.9 parts

To the first solution A16, the second solution A11 used in Example 11 is added, stirred, and defoamed for 5 minutes under a reduced pressure. Furthermore, a reaction catalyst (inorganic bismuth) is added, to provide a resin-film-forming solution (A16).

### Preparation of Resin-Film-Forming Solution (B16)

The following components are mixed and stirred to prepare a first solution B16.

Acrylic resin prepolymer A2 solution (solid content: 50 mass %): 50 parts

Long-chain polyol (polycaprolactonetriol, PLACCEL 308, manufactured by Daicel Corporation, molecular weight: 850, hydroxyl value: 190 to 200 mgKOH/g): 26 parts

Methylcyclohexane: 20 parts

Butyl acetate: 25 parts

To the first solution B16, the second solution A11 used in Example 11 is added, stirred, and defoamed for 5 minutes under a reduced pressure. Furthermore, a reaction catalyst (inorganic bismuth) is added, to provide a resin-film-forming solution (B16).

### Formation of Multilayered Resin Film (16)

The resin-film-forming solution (B16) is applied onto, with a wire bar, a polyimide film so as to have a thickness of 45 μm, and then cured at 80° C. for 2 hours subsequently at 130° C. for 30 minutes, to obtain, as a lower layer, a coating film having an average thickness of 25 μm.

Onto this coating film, the resin-film-forming solution (A16) is applied so as to have a thickness of 20 μm, and cured at 80° C. for 2 hours and then at 130° C. for 30 minutes, to form an upper layer having an average thickness of 10 μm.

In this way, a multilayered resin film (16) having an average thickness of 35 μm is obtained in which the upper layer containing photocatalyst particles is disposed on the lower layer not containing photocatalyst particles.

### Example 17

### Preparation of Resin-Film-Forming Solution (A17)

As in Example 9, the following components except for the photocatalyst-particle dispersion liquid A9 are mixed and stirred. To the mixture, the photocatalyst-particle dispersion liquid A9 is added and stirred to prepare a first solution A17.

Acrylic resin prepolymer A11 solution (solid content: 50 mass %): 50 parts

Long-chain polyol (polycaprolactonetriol, PLACCEL 308, manufactured by Daicel Corporation, molecular weight: 850, hydroxyl value: 190 to 200 mgKOH/g): 26 parts

Light stabilizer (trade name: TINUVIN 123, manufactured by BASF Japan Ltd.): 0.3 parts

Butyl acetate: 45 parts

Photocatalyst-particle dispersion liquid A9: 14.0 parts

To the first solution A17, the second solution A11 used in Example 11 is added, stirred, and defoamed for 5 minutes under a reduced pressure. Furthermore, a reaction catalyst (inorganic bismuth) is added, to provide a resin-film-forming solution (A17).

### Preparation of Resin-Film-Forming Solution (B17)

The following components are mixed and stirred to prepare a first solution B17.

Acrylic resin prepolymer A2 solution (solid content: 50 mass %): 50 parts

Long-chain polyol (polycaprolactonetriol, PLACCEL 308, manufactured by Daicel Corporation, molecular weight: 850, hydroxyl value: 190 to 200 mgKOH/g): 26 parts

Light stabilizer (trade name: TINUVIN 123, manufactured by BASF Japan Ltd.): 0.3 parts

Butyl acetate: 45 parts

To the first solution B17, the second solution A11 used in Example 11 is added, stirred, and defoamed for 5 minutes under a reduced pressure. Furthermore, a reaction catalyst (inorganic bismuth) is added, to provide a resin-film-forming solution (B17).

### Formation of Multilayered Resin Film (17)

The resin-film-forming solution (B17) is applied onto, with a wire bar, a polyimide film so as to have a thickness of 45 μm, and then cured at 80° C. for 2 hours and subsequently at 130° C. for 30 minutes, to obtain, as a lower layer, a coating film having an average thickness of 25 μm.

Onto the coating film, the resin-film-forming solution (A17) is applied so as to have a thickness of 25 m, and cured at 80° C. for 2 hours and subsequently at 130° C. for 30 minutes, to form an upper layer having an average thickness of 10 μm.

In this way, a multilayered resin film (17) having an average thickness of 35 μm is obtained in which the upper layer containing photocatalyst particles is disposed on the lower layer not containing photocatalyst particles.

### Comparative Example 2

### Preparation of Resin-Film-Forming Solution (H2)

As in Example 9, the following components except for the photocatalyst-particle dispersion liquid A9 are mixed and stirred. To the mixture, the photocatalyst-particle dispersion liquid A9 is added and stirred to prepare a first solution H2.

Acrylic resin prepolymer A2 solution (solid content: 50 mass %): 50 parts

Butyl acetate: 10 parts

Photocatalyst-particle dispersion liquid A9: 4.4 parts

In addition, the following second solution H2 is prepared.

Second solution H2 (multifunctional isocyanate, DURANATE TPA100, manufactured by Asahi Kasei Chemicals Corporation, compound name: polyisocyanurate of hexamethylene diisocyanate): 18 parts

To the first solution H2, the second solution H2 is added, stirred, and defoamed for 5 minutes under a reduced pressure. Furthermore, a reaction catalyst (inorganic bismuth) is added, to provide a resin-film-forming solution (H2).

### Formation of Monolayered Resin Film (H2)

The resin-film-forming solution (H2) is applied so as to have a thickness of 60 m, and cured at 80° C. for 2 hours and then at 130° C. for 30 minutes, to obtain a monolayered resin film (H2) having an average thickness of 35 μm.

Examples 9 to 17 and Comparative Example 2 are evaluated as in Example 5.

TABLE 3

| | | Upper layer (or monolayer) | | | Lower layer | | | Photocatalyst particles | |
|---|---|---|---|---|---|---|---|---|---|
| | | Photocatalyst | Film | Acrylic resin | Photocatalyst | Film | Acrylic resin | Particle | |
| | Layer | particle content | thickness | F atoms | particle content | thickness | F atoms are | size | |
| | configuration | [mass %] | [μm] | are contained or not | [mass %] | [μm] | contained or not | [nm] | Type |
| Example 9 | Monolayered | 0.5% | 35 | Contained | — | | | 100 | Visible-light |
| Example 10 | Monolayered | 2% | 35 | Contained | — | | | 100 | Visible-light |
| Example 11 | Monolayered | 1% | 40 | Contained | — | | | 100 | Visible-light |
| Example 12 | Monolayered | 0.1% | 35 | Contained | — | | | 100 | Visible-light |
| Example 13 | Monolayered | 30% | 47 | Contained | — | | | 100 | Visible-light |
| Example 14 | Monolayered | 5% | 42 | Contained | — | | | 100 | Visible-light |
| Example 15 | Monolayered | 1% | 30 | Contained | — | | | 100 | Visible-light |
| Example 16 | Multilayered | 1% | 10 | Contained | 0% | 25 | Not contained | 100 | Visible-light |
| Example 17 | Multilayered | 3% | 10 | Contained | 0% | 25 | Not contained | 100 | Visible-light |

| | | | | | | |
|---|---|---|---|---|---|---|
| Comparative | Monolayered | 1% | 35 | Not contained | — | — |
| Example 2 | | | | | | |

TABLE 4

| | Evaluations | | | | |
|---|---|---|---|---|---|
| | Self-healing | Antifouling | After long-term deterioration | After long-term deterioration | |
| | properties | properties | self-healing properties | antifouling properties | |
| | (recovery ratio) | (variation) | (recovery ratio) | (variation) | Resistance to |
| | [%] | [%] | [%] | [%] | microorganisms |
| Example 9 | 96% | 5% or less | 95% | 5% or less | 15% or less |
| Example 10 | 98% | 5% or less | 97% | 5% or less | 15% or less |
| Example 11 | 97% | 5% or less | 96% | 5% or less | 15% or less |
| Example 12 | 98% | 5% or less | 97% | 7% | 17% |
| Example 13 | 88% | 5% or less | 88% | 5% or less | 15% or less |
| Example 14 | 95% | 5% or less | 94% | 5% or less | 15% or less |
| Example 15 | 98% | 5% or less | 97% | 5% or less | 15% or less |
| Example 16 | 99% | 5% or less | 98% | 5% or less | 15% or less |
| Example 17 | 98% | 6% | 97% | 6% | 17% |
| Comparative | 40% | 5% or less | 35% | 15% | 70% or more |
| Example 2 | | | | | |

As is clear from Tables, in each of Examples, the surface protective resin film, which includes a cured product of a composition containing an acrylic resin having a hydroxyl value of 40 mgKOH/g or more and 280 mgKOH/g or less, a polyol having plural hydroxyl groups linked together via a carbon chain having 6 or more carbon atoms, and a multifunctional isocyanate, and contains photocatalyst particles, has high scratch resistance and high resistance to microorganisms, compared with Comparative Example 1 in which the surface protective resin film does not contain photocatalyst particles, and Comparative Example 2 in which the surface protective resin film including only the cured product of the composition not containing the polyol.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A surface protective resin member comprising:
a cured product of a composition containing
an acrylic resin having a hydroxyl value in a range of 40 mgKOH/g to 280 mgKOH/g,
a polyol having a plurality of hydroxyl groups linked together via a linear moiety of a carbon chain, the linear moiety having 6 or more carbon atoms, and
a multifunctional isocyanate; and
photocatalyst particles.

2. The surface protective resin member according to claim 1, wherein the acrylic resin contains fluorine atoms.

3. The surface protective resin member according to claim 1, wherein the photocatalyst particles have a number-average primary particle size in a range of 5 nm to 350 nm.

4. The surface protective resin member according to claim 1, wherein the photocatalyst particles have a number-average primary-particle size in a range of 5 nm to 180 nm.

5. The surface protective resin member according to claim 1, wherein the photocatalyst particles are visible-light photocatalyst particles.

6. The surface protective resin member according to claim 1, wherein a content ratio of the photocatalyst particles relative to an entirety of the surface protective resin member is in a range of 0.01 mass % to 30 mass %.

7. The surface protective resin member according to claim 1, wherein a content ratio of the photocatalyst particles relative to an entirety of the surface protective resin member is in a range of 0.05 mass % to 20 mass %.

8. A multilayered resin member comprising:
a first resin member that contains a cured product of a composition containing
an acrylic resin having a hydroxyl value in a range of 40 mgKOH/g to 280 mgKOH/g,
a polyol having a plurality of hydroxyl groups linked together via a linear moiety of a carbon chain, the linear moiety having 6 or more carbon atoms, and
a multifunctional isocyanate, and
that does not contain photocatalyst particles; and
a second resin member disposed on the first resin member and containing the surface protective resin member according to claim 1.

9. A solution set for forming a surface protective resin member, the solution set comprising:
a first solution containing an acrylic resin having a hydroxyl value in a range of 40 mgKOH/g to 280 mgKOH/g, and a polyol having a plurality of hydroxyl groups linked together via a carbon chain having 6 or more carbon atoms; and
a second solution containing a multifunctional isocyanate,
wherein at least one of the first solution and the second solution contains photocatalyst particles.

10. The solution set according to claim 9, wherein the acrylic resin contains fluorine atoms.

11. The solution set according to claim 9, wherein the photocatalyst particles have a number average primary particle size in a range of 5 nm to 350 nm.

12. The solution set according to claim 9, wherein the photocatalyst particles are visible light photocatalyst particles.

13. The solution set according to claim 9, wherein a content ratio of the photocatalyst particles relative to a total mass of the solution set is in a range of 0.001 mass % to 10 mass %.
